(19) United States
(12) Patent Application Publication
(10) Pub. No.: US 2026/0371171 A1
(43) Pub. Date: Nov. 19, 2026

(54) COMMUNICATION METHOD AND APPARATUS

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 19/753,766

(22) Filed: Jul. 24, 2026

Related U.S. Application Data
(63) Continuation of application No. PCT/CN2025/081194, filed on Mar. 7, 2025.

(30) Foreign Application Priority Data
Mar. 29, 2024 (CN) 202410383395.1

(51) Int. Cl. H04W 28/10

(52) U.S. Cl. CPC H04W 28/10

(57) ABSTRACT

Aspects of the present disclosure provide a communication method. In the communication method, first transmission rate limiting information of a first network is acquired. The first transmission rate limiting information is provided by a core network element of a mobile communication system for a service data flow of a user equipment. An encoding and decoding parameter of the service data flow is adjusted according to the first transmission rate limiting information and a wireless network change of the user equipment. Service data is encoded based on the adjusted encoding and decoding parameter to generate the service data flow. Apparatus and non-transitory computer-readable storage medium counterparts are also contemplated.

### RELATED APPLICATIONS

The present application is a continuation of International Application No. PCT/CN2025/081194, filed on Mar. 7, 2025, which claims priority to Chinese Patent Application No. 202410383395.1, filed on Mar. 29, 2024. The entire disclosures of the prior applications are hereby incorporated by reference.

### FIELD OF THE TECHNOLOGY

This application relates to the field of computer and communication technologies, including a communication method and apparatus, a computer-readable medium, and an electronic device.

### BACKGROUND

In related cellular mobile communication systems, such as the 5th-generation mobile communication technology (5G) and its subsequent evolved systems (such as 5G-Advanced (5G-A) and 6G), high-bandwidth interactive services are an important service type, such as cloud gaming, virtual reality (VR), augmented reality (AR), mixed reality (MR), extended reality (XR), cinematic reality (CR), and XR and media services (XRM). These high-bandwidth interactive services not only demand high transmission timeliness but also experience a significant increase in the volume of data generated at the application layer with the improvement of indicators such as resolution and frame rate. Since cellular mobile communication systems need to serve a large quantity of user equipment (UE), the problem that the transmission rate does not match the transmission rate required by the service data often arises, thereby affecting the smoothness of services at the application layer.

### SUMMARY

Aspects of this disclosure include a communication method and apparatus, a computer-readable medium, and an electronic device. Adaptive adjustment of an encoding and decoding parameter based on transmission rate limiting information is achieved, thereby helping improve resource utilization for handling multimedia services and enhance user experience, so as to better address the challenges posed by high-bandwidth interactive services to wireless network transmission.

An aspect of this disclosure provides a communication method. In the communication method, first transmission rate limiting information of a first network is acquired by a network device. The first transmission rate limiting information is provided by a core network element of a mobile communication system for a service data flow of a user equipment. An encoding and decoding parameter of the service data flow is adjusted according to the first transmission rate limiting information and a wireless network change of the user equipment. The adjusted encoding and decoding parameter is used to encode service data to generate the service data flow.

An aspect of this disclosure provides a communication method. In the communication method, transmission rate limiting information of a mobile communication system for a service data flow of a user equipment is acquired by a core network element of the mobile communication system. The transmission rate limiting information is provided to a network device that is configured to adjust an encoding and decoding parameter of the service data flow according to the transmission rate limiting information and a wireless network change of the user equipment. The adjusted encoding and decoding parameter is used to encode service data to generate the service data flow.

An aspect of this disclosure provides an apparatus. The apparatus includes processing circuitry configured to acquire first transmission rate limiting information of a first network provided by a core network element of a mobile communication system for a service data flow of a user equipment. The processing circuitry is configured to adjust an encoding and decoding parameter of the service data flow according to the first transmission rate limiting information and a wireless network change of the user equipment. The adjusted encoding and decoding parameter is used to encode service data to generate the service data flow.

An aspect of this disclosure provides a communication method, including: acquiring transmission rate limiting information provided by a core network element of a cellular mobile communication system for a service data flow of user equipment; and adjusting an encoding and decoding parameter of the service data flow according to the transmission rate limiting information, the adjusted encoding and decoding parameter being configured for encoding service data to generate the service data flow, and the service data flow being transmitted to the user equipment via the cellular mobile communication system.

An aspect of this disclosure provides a communication method, including: acquiring transmission rate limiting information of the cellular mobile communication system for a service data flow of user equipment; and providing the transmission rate limiting information to a network device, the adjusted encoding and decoding parameter being configured for encoding service data to generate the service data flow, and the service data flow being transmitted to the user equipment via the cellular mobile communication system.

An aspect of this disclosure provides a communication apparatus, including: a receiving unit configured to acquire transmission rate limiting information provided by a core network element of a cellular mobile communication system for a service data flow of user equipment; and an adjustment unit configured to adjust an encoding and decoding parameter of the service data flow according to the transmission rate limiting information, the adjusted encoding and decoding parameter being configured for encoding service data to generate the service data flow, and the service data flow being transmitted to the user equipment via the cellular mobile communication system.

An aspect of this disclosure provides a communication apparatus, including: an acquisition unit configured to acquire transmission rate limiting information of the cellular mobile communication system for a service data flow of user equipment; and a transmission unit configured to transmit the transmission rate limiting information for the service data flow to a network device, the adjusted encoding and decoding parameter being configured for encoding service data to generate the service data flow, and the service data flow being transmitted to the user equipment via the cellular mobile communication system.

An aspect of this disclosure provides a computer-readable medium, having a computer program stored therein, the computer program, when executed by a processor (an example of processing circuitry), implementing the communication method as described in the foregoing aspects.

An aspect of this disclosure provides an electronic device, including: one or more processors; and a memory configured to store one or more computer programs, the one or more computer programs, when executed by the one or more processors, causing the electronic device to implement the communication method as described in the foregoing aspects.

An aspect of this disclosure provides a computer program product, including a computer program, the computer program being stored in a computer-readable storage medium (e.g., a non-transitory computer-readable storage medium). A processor of an electronic device reads, from the computer-readable storage medium, and executes the computer program to cause the electronic device to perform the communication method provided in the foregoing aspects.

In the technical solutions provided in some aspects of this disclosure, an application side acquires transmission rate limiting information provided by a core network element for a service data flow, and then adjusts an encoding and decoding parameter of the service data flow according to the transmission rate limiting information, so that the application side can match the encoding and decoding parameter of the service data flow with the transmission rate limiting information according to the transmission rate limiting information acquired from the core network element. Adaptive adjustment of the encoding and decoding parameter based on the transmission rate limiting information is achieved, thereby helping improve resource utilization for handling multimedia services and enhance user experience, so as to better address the challenges posed by high-bandwidth interactive services to wireless network transmission.

The foregoing general descriptions and the following detailed descriptions are examples and explanatory and are not intended to limit this disclosure.

### BRIEF DESCRIPTION OF THE DRAWINGS

FIG. 1 illustrates a schematic diagram of a system architecture to which a technical solution of an aspect of this disclosure may be applied.

FIG. 2 illustrates a schematic diagram of a transmission process of a multimedia data packet according to an aspect of this disclosure.

FIG. 3 illustrates a flowchart of a communication method according to an aspect of this disclosure.

FIG. 4 illustrates a flowchart of a communication method according to an aspect of this disclosure.

FIG. 5 illustrates a flowchart of a communication method according to an aspect of this disclosure.

FIG. 6 illustrates a flowchart of exposing rate limiting information according to an aspect of this disclosure.

FIG. 7 illustrates a system architecture diagram of a trusted non-3rd generation partnership project (3GPP) access mode according to an aspect of this disclosure.

FIG. 8 illustrates a system architecture diagram of an untrusted non-3GPP access mode according to an aspect of this disclosure.

FIG. 9 illustrates a block diagram of a communication apparatus according to an aspect of this disclosure.

FIG. 10 illustrates a block diagram of a communication apparatus according to an aspect of this disclosure.

FIG. 11 illustrates a schematic structural diagram of a computer system suitable for implementing an electronic device according to an aspect of this disclosure.

### DETAILED DESCRIPTION

The following describes technical solutions in aspects of this disclosure with reference to the accompanying drawings. The described aspects are some of the aspects of this disclosure rather than all of the aspects. Other aspects are within the scope of this disclosure.

In the present disclosure, terms such as "first" and "second" are intended to distinguish between similar objects but do not necessarily indicate a specific order or sequence. Data used in this way may be interchanged in a proper circumstance, so that aspects of this disclosure described herein can be implemented in a sequence different from those shown in the drawings or described herein. In addition, terms "include", "have", and any variants thereof are intended to cover a non-exclusive inclusion, for example, a process, method, system, product, or device that includes a series of steps or units is not necessarily limited to the steps or units specified expressly, but may include other steps or units not specified expressly or may include steps or units inherent to the process, method, product or device.

In the present disclosure, the term "at least one" means one or more, and "a plurality of" means two or more. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Examples of terms involved in the aspects of the disclosure are briefly introduced. The descriptions of the terms are provided as examples and are not intended to limit the scope of the disclosure.

With the development of cellular mobile communication systems, such as 5G and its subsequent evolved systems (such as 5G-A and 6G), many multimedia services requiring large data volumes and low latency have become widespread, such as cloud gaming services and interactive services like VR, AR, MR, XR, CR, etc.

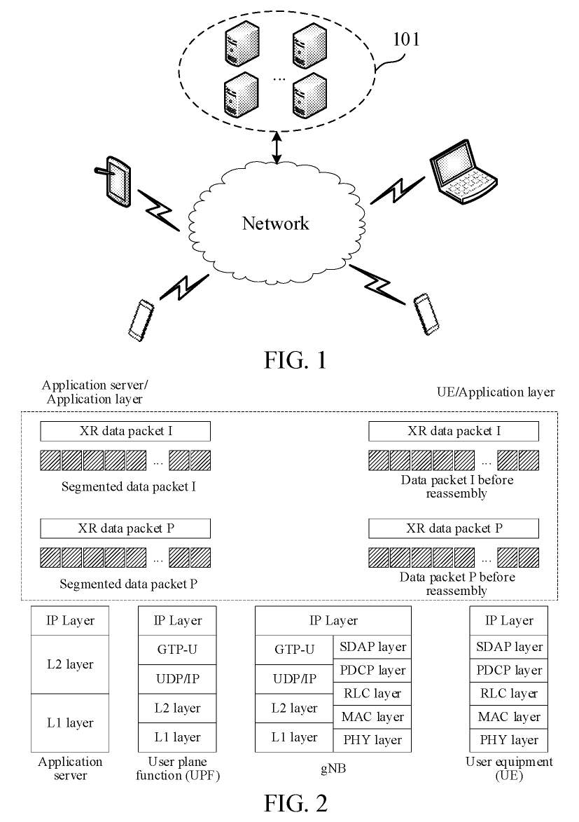

For example, when the network shown in FIG. 1 is applied to a cloud gaming scenario, a cloud server 101 is configured to run a cloud game. The cloud server 101 may render game pictures, encode audio signals and the rendered pictures, and transmit the encoded data resulting from encoding to game clients via the network. The game client may be user equipment (UE) having basic streaming media playback, human-computer interaction, and communication capabilities, etc., such as a smartphone, a tablet computer, a laptop computer, a desktop computer, a smart television, a smart home device, an in-vehicle terminal, and an aircraft. Alternatively, the game client may be an application program running on a terminal device. In some examples, the game client may decode the encoded data transmitted from the cloud server 101 to obtain analog audio and video signals, and play them back.

The network structure in FIG. 1 is an example of a network structure that can be configured to support a cloud gaming system, and does not limit the architecture of the cloud gaming system. For example, in other aspects, the cloud gaming system may further include a backend server for scheduling, and so on. In addition, the cloud server 101 may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The game clients may be directly or indirectly connected to the cloud server 101 in a wired or wireless communication protocol. This is not limited in this disclosure.

The network structure in FIG. 1 may alternatively be configured to support various multimedia-based interactive services. In the various multimedia-based interactive service application scenarios described above, due to the large size of multimedia data packets, they need to be divided into a plurality of data packets for transmission. As shown in FIG. 2, taking a 5G system as an example, a user plane mainly includes an application server (AS), a user plane function (UPF), a next generation nodeB (gNB), and a UE. The transmission of multimedia data packets is mainly in the downlink direction for some typical service scenarios, for example, from the AS to the UPF, and then to the UE via the gNB. During transmission, a multimedia data packet (taking an XR data packet as an example in FIG. 2) is segmented at the application layer of the application server. After the segmented data packets arrive at the UPF as IP packets, the 5G system transmits the sub-data packets to the UE via a PDU session. At the UE, the sub-data packets are delivered upward layer by layer from the protocol stack and reassembled to recover the multimedia data packet.

In the system shown in FIG. 2, L1 layer refers to a physical layer, which is configured to help that original data can be transmitted over various physical media. L2 layer refers to a data link layer, which provides services to a network layer based on services provided by the physical layer. Internet protocol (IP) layer is the network layer, which is configured to achieve data transmission between two end systems. UDP stands for user datagram protocol. GTP-U stands for general packet radio service (GPRS) tunneling protocol. PHY is short for physical. MAC stands for media access control. RLC stands for radio link control. PDCP stands for packet data convergence protocol. SDAP stands for service data adaptation protocol.

For multimedia services (e.g., XRM), it is common to segment a multimedia data packet of a frame into a plurality of data packets for transmission. A single multimedia service frame or a group of packets (GoP) may form data packets with a relatively large byte size, which need to be carried by a series of IP packets. Particular correlations exist among these IP packets. Wireless network bandwidth can be saved by processing these packets based on the correlations.

For example, assuming that transmission is performed using a plurality of IP packets, the plurality of IP packets may form a PDU set. If some packets in the PDU set are lost, the entire frame, the GoP, or the content of the other video portion may be undecodable, rendering the remaining packets in the PDU set meaningless to a decoder. However, if an application layer forward error correction (FEC) or other mechanisms is/are introduced, a media application layer has a packet loss recovery capability or anti-packet loss capability, and the remaining packets in the PDU set can still be decoded after some packets are discarded. In this case, it indicates that the remaining data in the PDU set is still meaningful for decoding at a receiver.

Meanwhile, multimedia services such as XRM have a high transmission rate with a large fluctuation range, while the 5G system (5GS) needs to serve a large quantity of UE. Therefore, the problem of mismatching between the transmission rate and that required by the service data may occur, which in turn affects the service effect.

In view of the above, an aspect of this disclosure provides a communication solution. A network device of an application side (i.e., a network device providing application service data, hereinafter referred to as "network device") may achieve, according to transmission rate limiting information acquired from a core network element, the matching of an encoding and decoding parameter of a service data flow with the transmission rate limiting information. Thus, adaptive adjustment of the encoding and decoding parameter based on the transmission rate limiting information is achieved, thereby helping improve resource utilization for handling multimedia services and enhance user experience, so as to better address the challenges posed by high-bandwidth interactive services to wireless network transmission.

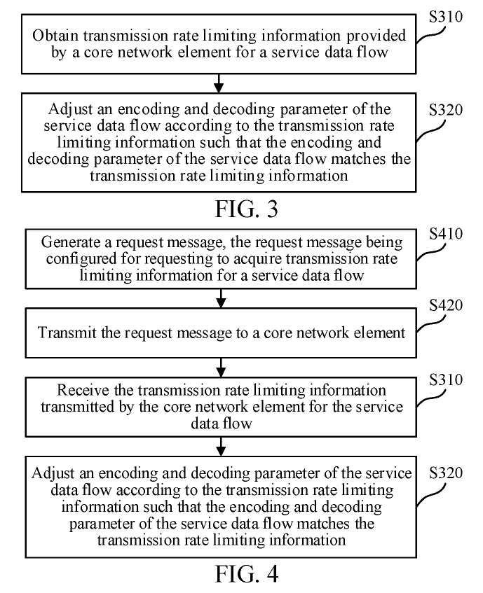

FIG. 3 illustrates a flowchart of a communication method according to an aspect of this disclosure. The communication method may be performed by a network device, for example, may be performed by an application function (AF) in a cellular mobile communication system, or may be performed by a terminal and a third-party AF device outside the cellular mobile communication system, e.g., an application server (AS) for multimedia services, or may be performed by other network elements or devices capable of implementing similar functions. Referring to FIG. 3, the communication method includes at least operations S310 to S320.

Operation S310: Receive transmission rate limiting information transmitted by a core network element for a service data flow.

Here, the core network element refers to a core network element of a cellular mobile communication system. In an aspect, the cellular mobile communication system may perform transmission rate limiting on all services of user equipment, and the transmission rate limiting information for the service data flow is transmission rate limiting information for a service data flow of the user equipment. In an aspect, the cellular mobile communication system may perform transmission rate limiting on a particular type of service of user equipment, and the transmission rate limiting information for the service data flow is transmission rate limiting information for a service data flow of the particular type of services of the user equipment. The service type may be, for example, a voice call, a video stream, or file transmission.

The service data flow may be a multimedia service data flow, such as a cloud game service data flow, a VR service data flow, an AR service data flow, an MR service data flow, an XR service data flow, an XRM service data flow, and a CR service data flow. The service data flow may be transmitted in the form of a service data packet set (i.e., a PDU set). This is because a data packet formed from a single multimedia service frame or a GoP may have a relatively large byte size and thus needs to be segmented into a series of data packets for carrying. These data packets have particular correlations among them, and therefore these correlated data packets may be referred to as a PDU set. In other aspects of this disclosure, the service data flow may alternatively be transmitted in a per-packet manner.

In an aspect, the transmission rate limiting information may include an aggregated maximum bit rate (AMBR), may include Rate limiting, or may include other parameters configured for indicating limiting on the transmission rate, etc. Rate limiting is configured to limit the number of requests that a specific entity (e.g., a UE, an IP address, or an application program) can transmit or the volume of data it can receive per unit time.

The transmission rate refers to a volume of data transmitted for the service data flow per unit time. The transmission rate is a primary indicator for measuring the transmission capability of a system. The transmission rate limiting information is configured for indicating information for limiting or regulating the transmission rate of the service data flow. For example, the specific format of the transmission rate limiting information may include a limited maximum transmission rate, may include a transmission rate limiting duration, or may include the limited maximum transmission rate and the transmission rate limiting duration, and so on.

The limited maximum transmission rate refers to a maximum transmission rate that can be used during the transmission of the service data flow, such as 300 kb/s and 500 kb/s. The transmission rate limiting duration refers to a duration during which the transmission rate of the service data flow is limited, such as one day, one week, and one month. The transmission rate may alternatively be limited until the end of a month, etc.

Operation S320: Adjust an encoding and decoding parameter of the service data flow according to the transmission rate limiting information such that the encoding and decoding parameter of the service data flow matches the transmission rate limiting information.

The adjusted encoding and decoding parameter is configured for encoding service data to generate the service data flow. The service data flow is transmitted to the user equipment via the cellular mobile communication system.

In an aspect, the network device that performs the method may encode the service data using the adjusted encoding and decoding parameter to generate the service data flow, and transmit the service data flow to the user equipment via the cellular mobile communication system.

In an aspect, the network device that performs the method may provide the adjusted encoding and decoding parameter to another network device. The another network device may encode the service data using the encoding and decoding parameter to generate the service data flow, and transmit the service data flow to the user equipment via the cellular mobile communication system.

In this way, the network device acquires the transmission rate limiting information provided by the core network element for the service data flow of the user equipment, and adjusts the encoding and decoding parameter of the service data flow according to the transmission rate limiting information such that the encoding and decoding parameter is configured for encoding the service data flow of the user equipment, enabling the network transmission rate to meet the transmission requirement of the service data flow. Thus, adaptive adjustment of the encoding and decoding parameter based on the transmission rate limiting information is achieved, thereby helping improve resource utilization for handling multimedia services and enhance user experience, so as to better address the challenges posed by high-bandwidth interactive services to wireless network transmission.

In an aspect, adjusting the encoding and decoding parameter of the service data flow according to the transmission rate limiting information may be as follows: adjusting, according to the transmission rate limiting information, at least one of the following parameters that correspond to the service data flow: a resolution, a frame rate, an encoding format, a bit rate, and a compression ratio.

In various aspects, when limiting the transmission rate of the service data flow, at least one encoding and decoding parameter may be adjusted. For example, if the encoding and decoding parameter needing to be adjusted is resolution, the resolution of the service data flow may be reduced, thereby reducing the volume of data transmitted per unit time. If the encoding and decoding parameter needing to be adjusted is bit rate, the bit rate of the service data flow may be reduced, thereby reducing the data transmission rate. If the encoding and decoding parameter needing to be adjusted is frame rate, the frame rate of the service data flow may be reduced, thereby also reducing the volume of data transmitted per unit time. If the encoding and decoding parameter needing to be adjusted is compression ratio, the compression ratio of the service data flow may be increased, thereby also reducing the volume of data transmitted. If the encoding and decoding parameter needing to be adjusted is encoding format, the volume of the encoded data of the service data flow may be reduced by adjusting the encoding format. For instance, if the encoding format used before limiting the transmission rate is H.264, H.265 may be adopted after limiting the transmission rate, so as to minimize the volume of the encoded data of the service data flow.

Since the reduction in the resolution, frame rate, bit rate, or the like of the service data flow may affect the quality of the service data flow, when adjusting the encoding and decoding parameter of the service data flow, the quality of the service data flow and the transmission rate may be considered comprehensively to achieve a balance between the quality of the service data flow and the transmission rate. Matching the encoding and decoding parameter of the service data flow with the transmission rate limiting information may mean ensuring that the encoded service data flow, when transmitted, does not exceed the maximum transmission rate required by the transmission rate limiting information. To help that the service data flow has higher quality, it is also possible, while satisfying the transmission rate limiting information, to help that the service data flow has higher quality by adjusting the encoding and decoding parameter of the service data flow as much as possible.

In an aspect, the transmission rate limiting information for the service data flow may alternatively be adjusted according to a wireless network change of the user equipment that processes the service data flow, whereby the encoding and decoding parameter of the service data flow is adjusted. For instance, after the encoding and decoding parameter of the service data flow is adjusted according to the transmission rate limiting information, the transmission rate limiting information for the service data flow may be adjusted according to the wireless network change of the user equipment that processes the service data flow, and the encoding and decoding parameter of the service data flow may be further adjusted according to the adjusted transmission rate limiting information. Alternatively, the transmission rate limiting information for the service data flow may be adjusted at any time (i.e., without first making an adjustment according to the transmission rate limiting information) according to the wireless network change of the user equipment that processes the service data flow. In this way, real-time adaptive adjustment of the encoding and decoding parameter of the service data flow according to the network connection status of the user equipment can be achieved, thereby improving service quality as much as possible while ensuring smooth service operation. For example, multimedia service data can be played back smoothly on the user equipment while adopting the best possible audio and video quality.

In an aspect, if the user equipment can receive the service data flow in a non-3GPP access mode, the transmission rate limiting on the service data flow may be lifted, i.e., the encoding and decoding parameter of the service data flow may be restored to the encoding and decoding parameter before adjustment. For example, the non-3GPP access mode may be a Wi-Fi access mode. Since the user equipment is capable of receiving the service data flow in the non-3GPP access mode, the transmission rate limiting on the service data flow may be lifted. Thus, the transmission efficiency of the service data flow can be improved while ensuring that the service data flow does not affect the 3GPP network, thereby meeting the processing requirements of multimedia services.

In an aspect, if the user equipment can receive the service data flow in the non-3GPP access mode, the maximum transmission rate included in the transmission rate limiting information may be increased, and the encoding and decoding parameter may be adjusted according to the increased maximum transmission rate. Thus, the transmission efficiency of the service data flow can be improved as well while ensuring that the service data flow does not affect the 3GPP network, thereby meeting the processing requirements of multimedia services.

In an aspect, if the user equipment switches a network receiving the service data flow, the transmission rate limiting information may be adjusted according to the switched network. For example, second transmission rate limiting information of the switched network for the service data flow may be acquired, and the encoding and decoding parameter may be adjusted according to the second transmission rate limiting information, where transmission rate limiting information corresponding to different networks is different. For example, when the user equipment is in a network with heavy traffic at a first position, the maximum transmission rate included in the transmission rate limiting information is relatively small. When the user equipment moves to a second position and is in a network with light traffic, the maximum transmission rate included in the transmission rate limiting information is relatively large (compared with the maximum transmission rate at the first position). For another example, when the user equipment processes the service data flow via a first network (e.g., a 4G network), the maximum transmission rate included in the transmission rate limiting information is relatively small. When the user equipment processes the service data flow via a second network (e.g., a 5G network), the maximum transmission rate included in the transmission rate limiting information is relatively large (compared with the maximum transmission rate when using the first network).

FIG. 4 illustrates a flowchart of a communication method according to an aspect of this disclosure. The communication method may be performed by a network device of an application side, for example, may be performed by an AF, or may be performed by an AS, or may be performed by other network elements or devices capable of implementing similar functions. Referring to FIG. 4, in addition to operations S310 and S320 shown in FIG. 3, the communication method further includes operations S410 and S420, which are described as follows:
Operation S410: Generate a request message, the request message being configured for requesting to acquire the transmission rate limiting information for the service data flow.
Operation S420: Transmit the request message to the core network element.

In an aspect, if the request message is transmitted by an AF, the AF transmitting the request message to the core network element may involve transmitting the request message to a policy control function (PCF). The request message enables the PCF to acquire and feed back the transmission rate limiting information for the service data flow. For example, the AF transmitting the request message to the PCF may mean first transmitting the request message to a network exposure function (NEF), and then forwarding it by the NEF to the PCF. Alternatively, the AF may directly transmit the request message to the PCF.

In an aspect, if the request message is transmitted by the AF, the AF transmitting the request message to the core network element may involve transmitting the request message to the PCF. The request message enables the PCF to instruct a session management function (SMF) to acquire and feed back the transmission rate limiting information for the service data flow. For example, the AF transmitting the request message to the PCF may mean first transmitting the request message to the NEF, and then forwarding it by the NEF to the PCF. Alternatively, the AF may directly transmit the request message to the PCF.

In an aspect, if the request message is transmitted by the AF, the AF transmitting the request message to the core network element may involve transmitting the request message to the PCF. Then, the PCF may instruct, via the SMF, an UPF to acquire and feed back the transmission rate limiting information for the service data flow. For example, the AF transmitting the request message to the PCF may mean first transmitting the request message to the NEF, and then forwarding it by the NEF to the PCF. Alternatively, the AF may directly transmit the request message to the PCF.

In an aspect, if the request message is transmitted by the AF, the AF transmitting the request message to the core network element may involve transmitting the request message to the NEF. Then, the NEF may acquire, from a network data analytics function (NWDAF), and feed back the transmission rate limiting information for the service data flow.

In an aspect, if the request message is transmitted by an AS, the AS may transmit the request message via the user plane to the core network element (e.g., a UPF) to acquire the transmission rate limiting information for the service data flow.

For example, in operation S310, the AS may obtain the transmission rate limiting information for the service data flow from the UPF.

In operation S320, the AS adjusts the encoding and decoding parameter of the service data flow according to the transmission rate limiting information such that the encoding and decoding parameter of the service data flow matches the transmission rate limiting information.

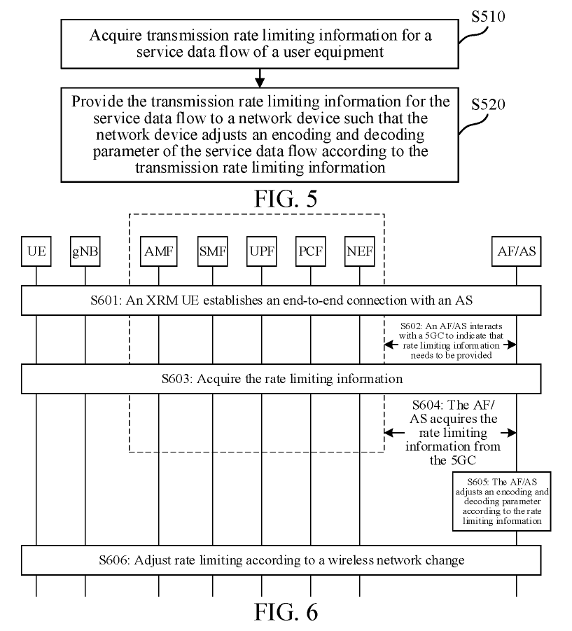

FIG. 5 illustrates a flowchart of a communication method according to an aspect of this disclosure. The communication method may be performed by a core network element (such as a PCF, an SMF, and a UPF) of a cellular mobile communication system, or may be performed by other network elements. Referring to FIG. 5, the communication method includes at least operations S510 to S520.

Operation S510: Acquire transmission rate limiting information for a service data flow of user equipment.

In an aspect, the core network element may acquire the transmission rate limiting information for the service data flow according to subscription information of the user equipment that processes the service data flow.

For instance, the core network element (e.g., a PCF, an SMF, or a UPF) may acquire, from a unified data management (UDM) network element, an AMBR for the user equipment or a protocol data unit (PDU) session, and use the AMBR as the transmission rate limiting information. For example, the AMBR may be an uplink AMBR, a downlink AMBR, or both an uplink AMBR and a downlink AMBR.

The AMBR is a parameter configured for describing the maximum bit rate or bandwidth that can be used by a user or a group of users in a mobile communication network, i.e., a bandwidth limitation, to prevent network congestion and ensure the quality of service. Therefore, the transmission rate limiting information may be determined by acquiring the AMBR.

In an aspect, the core network element may obtain the transmission rate limiting information, including the AMBR and rate limiting, such as a PCF, SMF, and UPF, and then expose the transmission rate limiting information to a network device. Rate limiting is configured to limit the number of requests that a specific entity (e.g., a UE, an IP address, or an application program) can transmit or the volume of data it can receive per unit time. For instance, it may be used in the UPF for QoS enforcement.

In an aspect, the core network element (e.g., PCF, SMF, or UPF) may acquire the transmission rate limiting information for the service data flow according to network traffic consumption of the user equipment that processes the service data flow.

In an aspect, it may be determined, according to a traffic policy and the network traffic consumption of the user equipment, whether network traffic consumed by the user equipment reaches a set traffic threshold. If the network traffic reaches the set traffic threshold, the transmission rate limiting information for the service data flow may be generated according to a set maximum transmission rate.

For instance, the set maximum transmission rate may be used as a limited maximum transmission rate for the service data flow. For example, when the network traffic consumed by the user equipment reaches the set traffic threshold, the maximum transmission rate (e.g., 300 kb/s or 500 kb/s) is used as the limited maximum transmission rate for the service data flow.

Alternatively, the limited maximum transmission rate for the service data flow may be calculated according to the set maximum transmission rate and a network traffic value required by a specified service other than the service data flow (e.g., a service with a higher priority). For instance, when the network traffic consumed by the user equipment reaches the set traffic threshold, a difference between the set maximum transmission rate (e.g., 300 kb/s or 500 kb/s) and the network traffic value required by the specified service (e.g., 100 kb/s or 50 kb/s) is used as the limited maximum transmission rate for the service data flow.

In an aspect, the core network element (e.g., PCF, SMF, or UPF) may acquire the transmission rate limiting information for the service data flow according to network traffic statistical information of the user equipment that processes the service data flow, where the network traffic statistical information includes rate change information of network traffic. For instance, if the core network element determines, by collecting statistics on traffic variation of the UE, that the UE consumes the set traffic value by the middle of each month, it may be determined that the transmission rate limiting for the UE will start from the middle of each month until the end of the month.

The transmission rate limiting information in this aspect of this disclosure may be one or a combination of the relevant parameters listed above.

Operation S520: Transmit the transmission rate limiting information for the service data flow to a network device such that the network device adjusts an encoding and decoding parameter of the service data flow according to the transmission rate limiting information.

The transmission rate limiting information is used by the network device to adjust the encoding and decoding parameter of the service data flow. The adjusted encoding and decoding parameter is configured to encode service data to generate the service data flow, and the service data flow is transmitted to the user equipment via the cellular mobile communication system.

In an aspect, the core network element may further receive a request message transmitted by the network device. The request message is configured for requesting to acquire the transmission rate limiting information for the service data flow. Then, the core network element transmits the transmission rate limiting information for the service data flow to the network device in response to the request message.

The network device may be an AF or an AS. For example, if a PCF transmits the transmission rate limiting information for the service data flow to an AF, the PCF may directly transmit the transmission rate limiting information to the AF, or may transmit the transmission rate limiting information to an NEF, which then forwards it to the AF. If an SMF transmits the transmission rate limiting information for the service data flow to the AF, the SMF may transmit the transmission rate limiting information to a PCF, which then forwards it to the AF. If a UPF transmits the transmission rate limiting information for the service data flow to the AF, the UPF may transmit, via an SMF, the transmission rate limiting information to a PCF, which then forwards it to the AF. If the UPF transmits the transmission rate limiting information for the service data flow to an AS, the UPF may transmit the transmission rate limiting information to the AS via the user plane.

For example, the process in which the network device adjusts the encoding and decoding parameter of the service data flow according to the transmission rate limiting information may refer to the technical solutions in the foregoing aspects, and will not be repeated here.

As such, the technical solutions in this aspect of this disclosure enable the network device to achieve, according to the transmission rate limiting information acquired from the core network element, the matching of the encoding and decoding parameter of the service data flow with the transmission rate limiting information. Thus, adaptive adjustment of the encoding and decoding parameter based on the transmission rate limiting information is achieved, thereby helping improve resource utilization for handling multimedia services and enhance user experience, so as to better address the challenges posed by high-bandwidth interactive services to wireless network transmission.

The implementation of the technical solutions in this aspect of this disclosure is described below with reference to FIGS. 6 - FIG. 8, taking the transmission of a data flow of XRM in a 5G system as an example.

The technical solutions in this aspect of this disclosure primarily involve a 5G core (5GC) network element exposing rate limiting information for a service data flow (for a UE or a PDU session) to an XRM server (i.e., an AS)/AF, and the AS/AF adjusting an encoding and decoding parameter of the multimedia service data flow according to the rate limiting information to proactively adapt to the rate range. For example, referring to FIG. 6, a process of exposing rate limiting information according to an aspect of this disclosure includes the following operations:
Operation S601: An XRM UE establishes an end-to-end connection with the AS.
For example, the XRM UE may establish a communication connection with the AS, and may transmit XRM service data at a set transmission rate.
Operation S602: The AF/AS interacts with the 5GC to indicate that rate limiting information needs to be provided.

In an aspect, the interaction between the AF and the 5GC may be implemented via a control capability exposure framework. For example, this may be achieved via AF-NEF-PCF-SMF-UPF (i.e., the AF transmits a request message to the NEF, the NEF transmits the request message to the PCF, the PCF transmits the request message to the SMF, and the SMF transmits the request message to the UPF), or via AF-NEF-PCF-SMF, or via AF-NEF-PCF, etc. The process of transmission via the NEF may be skipped, i.e., the AF may communicate directly with the PCF.

In an aspect, the AF may alternatively acquire the rate limiting information from an NWDAF via AF-NEF-NWDAF. In this approach, the rate limiting information may be determined through analysis in the NWDAF, and then acquired by the AF subscribing to the NWDAF.

In an aspect, the AS may alternatively acquire the rate limiting information from a core network element (e.g., a UPF) via the user plane.

Operation S603: The 5GC network element acquires the rate limiting information.

In an aspect, the way the 5GC network element acquires the rate limiting information may include acquiring it from UE subscription information, acquiring it according to traffic consumption information, or acquiring it through proactive detection by the network element, among others. These are described separately below:
In an aspect, the 5GC network element may acquire the rate limiting information from the subscription information of the UE. For example, AMBR information in an UDM may be obtained from the UE subscription information, including per-UE or per-Session information. During processes such as UE registration and PDU session establishment and modification, network elements such as a PCF, an SMF, an access and mobility management function (AMF), and a UPF can obtain this information, which belongs to internal information of the 5GS. In this aspect of this disclosure, after acquiring the AMBR-related information, the 5GC network element may expose it to the AF/AS.

For example, the AMBR-related information acquired by the 5GC network element may be per-UE (i.e., UE-AMBR) or per-Session (i.e., Session-AMBR).

For example, the AMBR-related information acquired by the 5GC network element may be an uplink AMBR, a downlink AMBR, or both uplink and downlink AMBRs.

In an aspect, the 5GC network element may acquire the rate limiting information according to the traffic consumption information.

For example, the traffic consumption information of the UE can be acquired from an operator's charging device. In addition, the UE may collect statistics on it. However, the statistical results of the UE side are often inaccurate, so the statistical results on the network side may be taken as the standard. The traffic consumption information of the UE is typically related to the user's traffic policy. For instance, the user may choose to have the rate limited when the traffic is exhausted. In this case, the rate limit value needs to be exposed to the AF/AS.

For example, the network traffic value required by services having a higher priority than the XRM may be further deducted on the network side, and then the rate limiting information after deducting such portion of traffic is provided to the AF/AS.

For example, when the network traffic consumed by the UE reaches a set traffic threshold (reaching the set traffic threshold may be considered as traffic exhaustion or near exhaustion), the set rate limit value (e.g., 300 kb/s) is deducted by the network traffic value required by a specified service (e.g., a service having a higher priority than XRM) (e.g., 100 kb/s), and the rate limiting information after deducting such portion of traffic (i.e., 300 kb/s to 100 kb/s) is provided to the AF/AS.

In an aspect, the 5GC network element may acquire the rate limiting information through proactive detection. This approach does not require acquiring information from a subscription or charging module. Instead, it may involve collecting statistics on the rate variation of the UE at the network element, and then acquiring the rate limiting information from the NWDAF using techniques such as artificial intelligence (AI) and machine learning (ML).

For example, a PDU session anchor (PSA) UPF may collect statistics on the rate variation of the UE. If it is determined that the UE consumes the set traffic value by the middle of each month, it may be determined that the transmission rate limiting for the UE will start from the middle of each month (the transmission rate is reduced and remains reduced for a long duration).

Operation S604: The AF/AS acquires the rate limiting information from the 5GC.

In an aspect, the rate limiting information acquired by the AF/AS from the 5GC includes, but is not limited to: a rate limit value (i.e., a maximum rate value), and an expected duration.

Operation S605: The AF/AS adjusts an encoding and decoding parameter according to the rate limiting information.

In an aspect, the AF/AS may select the encoding and decoding parameter, such as a resolution, a frame rate, a bit rate, and a compression ratio, according to the obtained rate limit value and the expected duration, to reduce the transmission rate of the service data flow.

Operation S606: Adjust rate limiting according to a wireless network change.

In an aspect, since the rate limiting may cause the parameter such as the resolution to be reduced, when the UE and the network change, the AF/AS may adjust the encoding and decoding parameter in time.

For example, if the UE changes, through handover, the network that it accesses, the rate limiting for the UE in different networks may be different, and the rate limiting in the new network is to be used.

For example, when the UE also has non-3GPP access capability, if it accesses a new Wi-Fi network that can be configured to transmit an XRM service data flow, the rate limiting may be lifted.

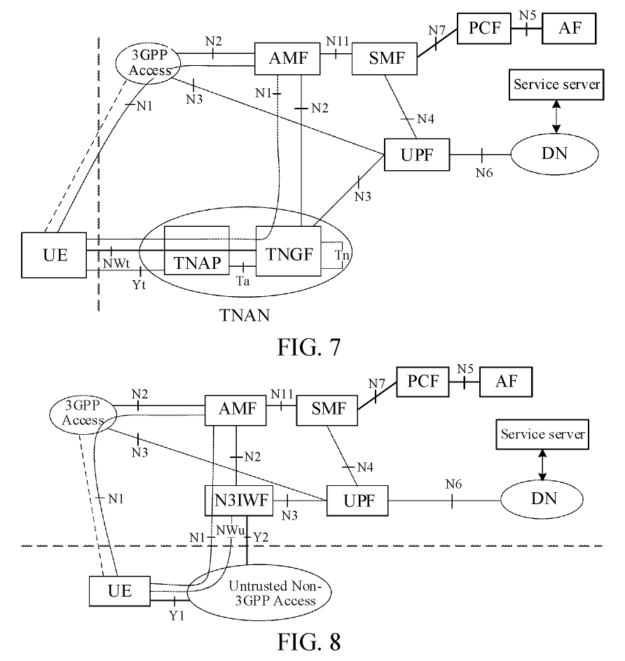

For example, if the UE has the non-3GPP access capability, the UE may access the core network either in a trusted non-3GPP access mode or in an untrusted non-3GPP access mode. For example, as shown in FIG. 7, in a system architecture in the trusted non-3GPP access mode, a trusted non-3GPP access network (TNAN) is connected to the core network elements AMF and UPF. The UE may access the 5G core network via the TNAN, or, if the UE has the capability of 3GPP radio access technology (RAT), it may alternatively access the 5G core network via 3GPP access. The TNAN includes a trusted non-3GPP access point (TNAP) and a trusted non-3GPP gateway function (TNGF), and the service server, i.e., AS, is located at the backend of the 5G core network and connected to a data network (DN).

As shown in FIG. 8, in a system architecture in the untrusted non-3GPP access mode, a non-3GPP interworking function (N3IWF) is connected to the core network elements AMF and UPF. The UE may access the N3IWF in the untrusted non-3GPP access mode (e.g., the UE establishes an Internet protocol security (IPSec) tunnel with the N3IWF to connect to the 5G core network in the untrusted non-3GPP access mode), and access the 5G core network via the N3IWF. Alternatively, if the UE has the capability of 3GPP RAT, it may access the 5G core network via 3GPP access. The service server, i.e., AS, is located at the backend of the 5G core network and connected to the DN.

Based on the foregoing, the technical solutions in this aspect of this disclosure enable the encoding and decoding parameter configuration at the application layer to proactively match the transmission rate limiting information, such that the complexity and blindness of rate adaptation algorithms are reduced, thereby helping improve resource utilization for handling multimedia services and enhance user experience, so as to better address the challenges posed by high-bandwidth interactive services to wireless network transmission.

The technical solutions in this aspect of this disclosure are not only applicable to 5G systems, but also applicable to future evolved mobile communication systems. Furthermore, the technical solutions in this aspect of this disclosure may be applicable to other multimedia services in addition to XRM.

The apparatus aspects of this disclosure, which can be utilized to perform the communication methods in the foregoing aspects of this disclosure, are described below. For example of details not disclosed in the apparatus aspects of this disclosure, reference is made to the aspects of the communication methods of this disclosure as described above.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

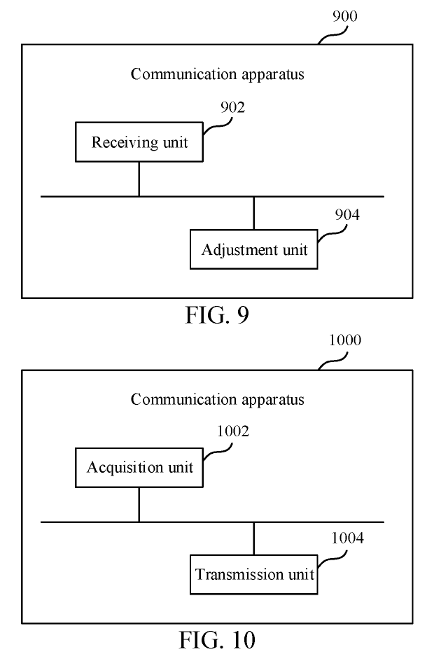

FIG. 9 illustrates a block diagram of a communication apparatus according to an aspect of this disclosure. The communication apparatus may be applied to an AF, or may be applied to other network elements capable of implementing similar functions.

Referring to FIG. 9, the communication apparatus 900 according to an aspect of this disclosure includes a receiving unit 902 and an adjustment unit 904.

The receiving unit 902 is configured to receive transmission rate limiting information transmitted by a core network element for a service data flow. The adjustment unit 904 is configured to adjust an encoding and decoding parameter of the service data flow according to the transmission rate limiting information such that the encoding and decoding parameter of the service data flow matches the transmission rate limiting information.

In an aspect, based on the foregoing solution, the communication apparatus 900 further includes: a generation unit configured to generate a request message, the request message being configured for requesting to acquire the transmission rate limiting information for the service data flow; and a transmission unit configured to transmit the request message to the core network element.

In an aspect, based on the foregoing solutions, the transmission unit is configured to transmit the request message to the core network element in at least one of the following manners:
transmitting the request message to a policy control function, enabling the policy control function to acquire and feed back the transmission rate limiting information for the service data flow;
transmitting the request message to the policy control function, enabling the policy control function to instruct a session management function to acquire and feed back the transmission rate limiting information for the service data flow;
transmitting the request message to the policy control function, enabling the policy control function to instruct, via the session management function, a user plane function to acquire and feed back the transmission rate limiting information for the service data flow; and
transmitting the request message to a network exposure function, enabling the network exposure function to acquire, from a network data analytics function, and feed back the transmission rate limiting information for the service data flow.

In an aspect, based on the foregoing solutions, the process in which the transmission unit transmits the request message to the policy control function includes:
transmitting the request message to the network exposure function, enabling the network exposure function to forward the request message to the policy control function; or
directly transmitting the request message to the policy control function.

In an aspect, based on the foregoing solutions, the transmission rate limiting information includes at least one of the following information: a limited maximum transmission rate and a transmission rate limiting duration.

In an aspect, based on the foregoing solutions, adjusting the encoding and decoding parameter of the service data flow according to the transmission rate limiting information includes: adjusting, according to the transmission rate limiting information, at least one of the following parameters that correspond to the service data flow: a resolution, a frame rate, an encoding format, a bit rate, and a compression ratio.

In an aspect, based on the foregoing solutions, the adjustment unit 904 is further configured to: adjust the encoding and decoding parameter of the service data flow according to a wireless network change of the user equipment that processes the service data flow.

In an aspect, based on the foregoing solutions, the adjustment unit 904 is configured to: if the user equipment can receive the service data flow in a non-3GPP access mode, lift the transmission rate limiting on the service data flow; or
if the user equipment can receive the service data flow in the non-3GPP access mode, increase the maximum transmission rate included in the transmission rate limiting information; or
if the user equipment switches a network receiving the service data flow, adjust the transmission rate limiting information according to the switched network, where transmission rate limiting information corresponding to different networks is different.

FIG. 10 illustrates a block diagram of a communication apparatus according to an aspect of this disclosure. The communication apparatus may be applied to a core network element (such as a PCF, an SMF, and a UPF), or may be applied to other network elements.

Referring to FIG. 10, the communication apparatus 1000 according to an aspect of this disclosure includes an acquisition unit 1002 and a transmission unit 1004.

The acquisition unit 1002 is configured to acquire transmission rate limiting information for a service data flow. The transmission unit 1004 is configured to transmit the transmission rate limiting information for the service data flow to a network device, enabling the network device to adjust an encoding and decoding parameter of the service data flow according to the transmission rate limiting information.

In an aspect, based on the foregoing solution, the acquisition unit 1002 is configured to acquire the transmission rate limiting information for the service data flow in at least one of the following manners:
acquiring the transmission rate limiting information for the service data flow according to subscription information of the user equipment that processes the service data flow;
acquiring the transmission rate limiting information for the service data flow according to network traffic consumption of the user equipment that processes the service data flow; and
acquiring the transmission rate limiting information for the service data flow according to network traffic statistical information of the user equipment that processes the service data flow, where the network traffic statistical information includes rate change information of network traffic.

In an aspect, based on the foregoing solutions, the operation of acquiring, by the acquisition unit 1002, the transmission rate limiting information for the service data flow according to the subscription information of the user equipment that processes the service data flow includes: acquiring an aggregated maximum bit rate for the user equipment or a protocol data unit (PDU) session from a unified data management network element, and using the aggregated maximum bit rate as the transmission rate limiting information.

The aggregated maximum bit rate includes at least one of an uplink aggregated maximum bit rate and a downlink aggregated maximum bit rate.

In an aspect, based on the foregoing solutions, the operation of acquiring, by the acquisition unit 1002, the transmission rate limiting information for the service data flow according to the network traffic consumption of the user equipment that processes the service data flow includes: if network traffic consumed by the user equipment is determined to reach a set traffic threshold according to a traffic policy and the network traffic consumption of the user equipment, generating the transmission rate limiting information for the service data flow according to a set maximum transmission rate.

In an aspect, based on the foregoing solutions, the operation of acquiring, by the acquisition unit 1002, the transmission rate limiting information for the service data flow according to the set maximum transmission rate includes: using the set maximum transmission rate as a limited maximum transmission rate for the service data flow; or
calculating the limited maximum transmission rate for the service data flow according to the set maximum transmission rate and a network traffic value required by a specified service other than the service data flow.

In an aspect, based on the foregoing solutions, the communication apparatus further includes: a receiving unit configured to receive a request message transmitted by the network device, the request message being configured to require acquiring the transmission rate limiting information for the service data flow. The transmission unit 1004 is configured to transmit the transmission rate limiting information to the network device in response to the request message.

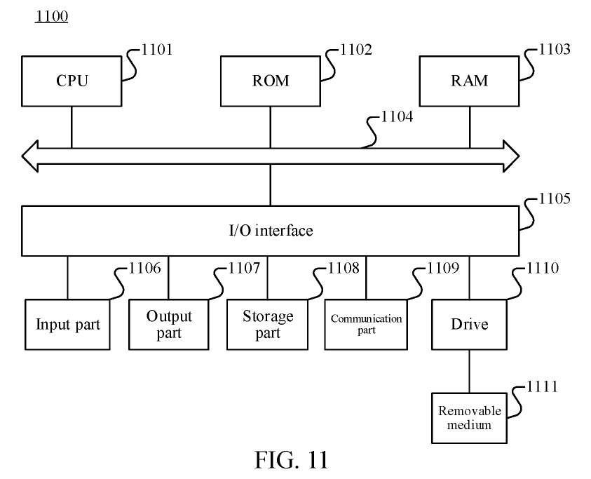

FIG. 11 illustrates a schematic structural diagram of a computer system suitable for implementing an electronic device according to an aspect of this disclosure. The electronic device may be the AF or the core network element as described in the foregoing aspects.

The computer system 1100 of the electronic device shown in FIG. 11 is an example, and does not constitute any limitation on the function and scope of use of the aspects of this disclosure.

As shown in FIG. 11, the computer system 1100 may include a central processing unit (CPU) 1101, which may perform various suitable actions and processes based on a program stored in a read-only memory (ROM) 1102 or a program loaded from a storage part 1108 into a random access memory (RAM) 1103, for example, perform the method described in the foregoing aspects. The RAM 1103 further has various programs and data required for system operation stored therein. The CPU 1101, the ROM 1102, and the RAM 1103 are connected to one another via a bus 1104. An input/output (I/O) interface 1105 is also connected to the bus 1104.

The following components may be connected to the I/O interface 1105: an input part 1106 including a keyboard, a mouse, and the like; an output part 1107 including a cathode ray tube (CRT), a liquid crystal display (LCD), a speaker, and the like; the storage part 1108 including a hard disk and the like; and a communications part 1109 including a network interface card such as a local area network (LAN) card or a modem. The communication part 1109 performs communication processing via a network such as the Internet. A drive 1110 is also connected to the I/O interface 1105 as required. A removable medium 1111, such as a magnetic disk, an optical disk, a magneto-optical disk, and a semiconductor memory, is mounted on the drive 1110 as needed, so that a computer program read therefrom is installed into the storage part 1108 as needed.

In an aspect, the process described above with reference to the flowchart may be implemented as a computer software program. For example, an aspect of this disclosure includes a computer program product, including a computer program carried on a computer-readable medium, the computer program being configured to perform the methods shown in the flowcharts. In such an aspect, the computer program may be downloaded and installed from the network via the communication part 1109, and/or may be installed from the removable medium 1111. When the computer program is executed by the CPU 1101, various functions defined in the system of this disclosure are performed.

The computer-readable medium illustrated in this aspect of this disclosure may be a computer-readable signal medium, a computer-readable storage medium (e.g., a non-transitory computer-readable storage medium), or any combination thereof. The computer-readable storage medium may be, for example (but is not limited to) an electric, magnetic, optical, electromagnetic, infrared, or semi-conductive system, apparatus, or device, or any combination of the above. More specific examples of the computer-readable storage medium may include but be not limited to an electrical connection with one or more wires, a portable computer disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this disclosure, the computer-readable storage medium may be any tangible medium including or storing a computer program, and the computer program may be used by or used in combination with an instruction execution system, apparatus or device. In this disclosure, the computer-readable signal medium may include a data signal propagated in a baseband or propagated as a part of a carrier, and carries a computer-readable computer program therein. The data signal propagating in such a manner may take a plurality of forms, including, but not limited to, an electromagnetic signal, an optical signal, or any appropriate combination thereof. The computer-readable signal medium may alternatively be any computer-readable medium except the computer-readable storage medium. The computer-readable medium may send, propagate or transmit a program used by or used in combination with an instruction execution system, apparatus or device. The computer program included in the computer-readable medium may be transmitted by using any suitable medium, including but not limited to: a wireless medium, a wire, and the like, or any appropriate combination thereof.

The flowcharts and block diagrams in the accompanying drawings illustrate possible system architectures, functions and operations that may be implemented by a system, a method, and a computer program product according to various aspects of this disclosure. Each block in the flowcharts or block diagrams may represent a module, a program segment or a part of code, and the module, the program segment or the part of code includes one or more executable instructions for implementing specified logic functions. In some alternative implementations, functions annotated in the blocks may alternatively be executed in a different order from those annotated in the accompanying drawings. For example, two successively shown blocks may actually be executed in parallel substantially, or may be executed in reverse order sometimes, depending on the functions involved. Each block in the block diagrams or flowcharts and the combination of the blocks in the block diagrams or the flowcharts may be implemented by a dedicated hardware-based system that performs specified functions or operations, or may be implemented by a combination of dedicated hardware and a computer program.

Related units described in the aspects of this disclosure may be implemented by software, or may be implemented by hardware. The described units may alternatively be set in a processor. The names of these units do not constitute a limitation on the units themselves.

In an aspect, this disclosure further provides a computer-readable medium. The computer-readable medium may be contained in the electronic device described in the foregoing aspect, or may exist alone without being assembled in the electronic device. The above-mentioned computer-readable medium carries one or more computer programs which, when executed by the electronic device, cause the electronic device to implement the methods described in the foregoing aspects.

Although a number of modules or units of the device for execution are mentioned in the description above, this division is not mandatory. In fact, according to the implementations of this disclosure, the features and functions of two or more modules or units described above may be embodied in one module or unit. On the contrary, the features and functions of the one module or unit described above may be further divided to be embodied by a plurality of modules or units.

Through the foregoing description of the implementations, the implementations described herein may be implemented by software, or may be implemented by software in combination with necessary hardware. Therefore, the technical solutions according to the implementations of this disclosure may be embodied in the form of a software product. The software product may be stored in a non-volatile storage medium (which may be a CD-ROM, a USB flash drive, a removable hard disk, or the like) or on a network, and includes a plurality of instructions to cause an electronic device to perform the methods according to the implementations of this disclosure.

For example, the electronic device may be an AF, and then the AF may perform the communication method shown in FIGS. 3 or FIG. 4. For another example, the electronic device may be a core network element, and then the core network element may perform the communication method shown in FIG. 5.

The technical features of the foregoing aspects may be combined in different manners to form other aspects. To make the description concise, not all possible combinations of the technical features in the foregoing aspects are described. However, the combinations of these technical features shall be considered as falling within the scope recorded by this description provided that no conflict exists.

Other aspects of this disclosure may be conceived after considering the description and practicing the implementations disclosed herein. This disclosure is intended to cover any variation, use, or adaptive change of this disclosure. The variation, use, or adaptive change follows the general principles of this disclosure and includes common knowledge or related technical means in the technical field that are not disclosed by this disclosure.

This disclosure is not limited to the precise structures that have been described above and shown in the accompanying drawings, and can be modified and changed in many ways without departing from the scope of this disclosure.

The foregoing disclosure includes some aspects of this disclosure which are not intended to limit the scope of this disclosure. Other aspects shall also fall within the scope of this disclosure.

What is claimed is:

1. A communication method, comprising:
acquiring first transmission rate limiting information of a first network provided by a core network element of a mobile communication system for a service data flow of a user equipment; and
adjusting, by a network device, an encoding and decoding parameter of the service data flow according to the first transmission rate limiting information and a wireless network change of the user equipment, service data being encoded based on the adjusted encoding and decoding parameter to generate the service data flow.

2. The communication method according to claim 1, further comprising:
generating a request message that is configured to request the first transmission rate limiting information for the service data flow; and
transmitting the request message to the core network element.

3. The communication method according to claim 2, wherein the transmitting comprises at least one of:
transmitting the request message to a policy control function, the request message enabling the policy control function to acquire and feed back the first transmission rate limiting information for the service data flow;
transmitting the request message to the policy control function, the request message enabling the policy control function to instruct a session management function to acquire and feed back the first transmission rate limiting information for the service data flow;
transmitting the request message to the policy control function, the request message enabling the policy control function to instruct, via the session management function, a user plane function to acquire and feed back the first transmission rate limiting information for the service data flow; or
transmitting the request message to a network exposure function, the request message enabling the network exposure function to acquire, from a network data analytics function, and feed back the first transmission rate limiting information for the service data flow.

4. The communication method according to claim 3, wherein the transmitting the request message to the policy control function comprises one of:
transmitting the request message to the network exposure function, the request message enabling the network exposure function to forward the request message to the policy control function; or
transmitting the request message to the policy control function.

5. The communication method according to claim 1, wherein the first transmission rate limiting information includes at least one of a limited maximum transmission rate or a transmission rate limiting duration.

6. The communication method according to claim 1, wherein the adjusting comprises:
adjusting, according to the first transmission rate limiting information, at least one of parameters that correspond to the service data flow, the parameters including a resolution, a frame rate, an encoding format, a bit rate, and a compression ratio.

7. The communication method according to claim 1, wherein when the user equipment switches to receiving the service data flow in a non-3rd generation partnership project (3GPP) access mode, the adjusting comprises:
restoring the adjusted encoding and decoding parameter of the service data flow to the encoding and decoding parameter before the adjustment.

8. The communication method according to claim 1, wherein when the user equipment switches to receiving the service data flow in a non-3GPP access mode, the adjusting comprises:
increasing a maximum transmission rate included in the first transmission rate limiting information; and
adjusting the encoding and decoding parameter according to the increased maximum transmission rate.

9. The communication method according to claim 1, wherein when the user equipment switches from the first network to a second network to receive the service data flow, the adjusting comprises:
acquiring second transmission rate limiting information of the second network for the service data flow; and
adjusting the encoding and decoding parameter according to the second transmission rate limiting information, the first and second transmission rate limiting information being different.

10. A communication method, comprising:
acquiring, by a core network element of a mobile communication system, transmission rate limiting information of the mobile communication system for a service data flow of a user equipment; and
providing the transmission rate limiting information to a network device that is configured to adjust an encoding and decoding parameter of the service data flow according to the transmission rate limiting information and a wireless network change of the user equipment, service data being encoded based on the adjusted encoding and decoding parameter to generate the service data flow.

11. The communication method according to claim 10, wherein the acquiring comprises:
acquiring the transmission rate limiting information for the service data flow according to at least one of subscription information, network traffic consumption information, or network traffic statistical information of the user equipment that processes the service data flow,
wherein the network traffic statistical information includes rate change information of network traffic.

12. The communication method according to claim 10, wherein
the acquiring comprises:
acquiring an aggregated maximum bit rate for the user equipment or a protocol data unit (PDU) session from a unified data management network element;
the transmission rate limiting information includes the aggregated maximum bit rate; and
the aggregated maximum bit rate includes at least one of an uplink aggregated maximum bit rate or a downlink aggregated maximum bit rate.

13. The communication method according to claim 10, wherein the acquiring comprises:
when a network traffic consumed by the user equipment is determined to reach a preset traffic threshold according to a traffic policy and network traffic consumption information of the user equipment, generating the transmission rate limiting information for the service data flow according to a preset maximum transmission rate.

14. The communication method according to claim 13, wherein the generating comprises:
using the preset maximum transmission rate as a limited maximum transmission rate for the service data flow; or
calculating the limited maximum transmission rate for the service data flow according to the preset maximum transmission rate and a network traffic value required by a service different from the service data flow.

15. The communication method according to claim 10, further comprising:
receiving a request message transmitted by the network device, the request message being configured to request the transmission rate limiting information for the service data flow; and
transmitting the transmission rate limiting information to the network device in response to the request message.

16. An apparatus, comprising processing circuitry configured to:
acquire first transmission rate limiting information of a first network provided by a core network element of a mobile communication system for a service data flow of a user equipment; and
adjust an encoding and decoding parameter of the service data flow according to the first transmission rate limiting information and a wireless network change of the user equipment, service data being encoded based on the adjusted encoding and decoding parameter to generate the service data flow.

17. The apparatus according to claim 16, wherein the processing circuitry is configured to:
generate a request message that is configured to request the first transmission rate limiting information for the service data flow; and
transmit the request message to the core network element.

18. The apparatus according to claim 17, wherein the processing circuitry is configured to:
transmit the request message to a policy control function, the request message enabling the policy control function to acquire and feed back the first transmission rate limiting information for the service data flow;
transmit the request message to the policy control function, the request message enabling the policy control function to instruct a session management function to acquire and feed back the first transmission rate limiting information for the service data flow;
transmit the request message to the policy control function, the request message enabling the policy control function to instruct, via the session management function, a user plane function to acquire and feed back the first transmission rate limiting information for the service data flow; or
transmit the request message to a network exposure function, the request message enabling the network exposure function to acquire, from a network data analytics function, and feed back the first transmission rate limiting information for the service data flow.

19. The apparatus according to claim 18, wherein the processing circuitry is configured to:
transmit the request message to the network exposure function, the request message enabling the network exposure function to forward the request message to the policy control function; or
transmit the request message to the policy control function.

20. The apparatus according to claim 16, wherein the first transmission rate limiting information includes at least one of a limited maximum transmission rate or a transmission rate limiting duration.
